(19) United States
(12) Patent Application Publication
(10) Pub. No.: US 2024/0233352 A1
(43) Pub. Date: Jul. 11, 2024

(54) METHOD FOR FUSING MEASUREMENT DATA CAPTURED USING DIFFERENT MEASUREMENT MODALITIES

(71) Applicant: ROBERT BOSCH GMBH, Stuttgart (DE)

(72) Inventors: Balint Szollosi-Nagy, Budapest (HU); Ernest-Adrian Scheiber, Budapest (HU); Istvan Remenyi, Tata (HU); Zoltan Karasz, Budapest (HU)

(21) Appl. No.: 18/547,605

(22) PCT Filed: Feb. 18, 2022
(86) PCT No.: PCT/EP2022/054066

§ 371 Date: Aug. 23, 2023

(30) Foreign Application Priority Data
Feb. 24, 2021 (DE) 10 2021 104 418.9

(51) Int. Cl. G06V 10/80; G06T 7/73; G06V 10/774; G06V 10/776; G06V 10/82; G06V 20/58

(52) U.S. Cl. CPC G06V 10/806; G06T 7/73; G06V 10/774; G06V 10/776; G06V 10/82; G06V 20/58; G06T 2207/10028; G06T 2207/20081; G06T 2207/20084; G06T 2207/30252

(57) ABSTRACT

A method for fusing first measurement data. The method include: determining a first latent representation of features from the first measurement data; decoding first information about features from the first latent representation; determining a second latent representation of features from the second measurement data; decoding second information about features from the second latent representation; modifying features in the first latent representation based on features in the second latent representation; modifying features in the second latent representation based on features in the first latent representation; decoding updated information about features from the updated first latent representation; and decoding updated information about features from the updated second latent representation.

### FIELD

The present invention relates to the processing of measurement data which were acquired by a physical observation of a scene in information and can be used for actuating technical systems such as vehicles, for instance.

### BACKGROUND INFORMATION

A vehicle that is driven in an at least partially automated manner must react to objects and events in its environment. For this purpose, the environment of the vehicle is monitored using a multitude of different sensors, e.g., cameras, radar sensors and LIDAR sensors. The measurement data acquired by these different sensors are often fused for a final determination as to which objects are present in the environment of the vehicle. PCT Patent Application No. WO 2018/188 877 A1 describes an exemplary method for such a sensor-spanning fusion of measurement data.

### SUMMARY

The present invention provides a method for fusing first measurement data acquired by monitoring a scene using a first measuring modality with measurement data acquired by monitoring the same scene using a second measuring modality. For example, the scene may be a traffic scene, and a vehicle equipped with sensors that acquire the first measurement data and the second measurement data may be part of this traffic scene.

According to an example embodiment of the present invention, in the course of the method, a first feature detector is used to determine a first latent representation of features from the first measurement data. Using a first decoder, first information about these features is decoded via these features from this first latent representation.

In the same way, a second latent representation of features is determined from the second measurement data with the aid of a second feature detector. Using a second decoder, second information about these features is decoded via these features from this second latent representation. The features determined by the second feature detector may differ from the features determined by the first feature detector.

According to an example embodiment of the present invention, in addition to the positions of features in space, the information about features that are decoded by the first decoder and/or the second decoder may particularly also include one or more of the following:
classifications,
confidences of classifications,
dimensions, and
orientations
   of objects that are represented by the features in the first and second latent representation. These are variables that are of special importance for evaluating the scene so that inferences may be drawn therefrom. In particular classifications of objects and the confidence of such classifications are important for determining a semantic meaning of the scene. Dimensions and orientations are especially important for predicting the future development of traffic situations.

According to an example embodiment of the present invention, in the course of the method, features in the first latent representation are modified based on features in the second latent representation according to a first predetermined update function. This produces an updated first latent representation. The first update function is a function of a distance between the position of the feature decoded from the first latent representation and the position of the feature decoded from the second latent representation.

In the same way, features in the second latent representation are modified based on features in the first latent representation according to a second predetermined update function. This produces an updated second latent representation. The second update function is a function of a distance between the position of the feature decoded from the second latent representation and the position of the feature decoded from the first latent representation.

With the aid of the first decoder, updated information about features from the updated first latent representation is decoded. In the same way, updated information about features from the updated second latent representation is decoded with the aid of the second decoder.

In other words, information may “flow” from features in the first latent representation into certain other features in the second representation, and of features in the second latent representation into certain other features in the first latent representation. Between which features such a “flow” is permitted and how strong or intensive such a flow should be is made dependent on a “neighbor relationship” in space between features that are decoded from the first and second latent representations by the respective first and second decoder.

The inventors have found out that when one and the same scene is simultaneously monitored by two different measuring modalities, synergistic effects between these measuring modalities are able to be utilized in this way. That means that each measuring modality can contribute its specific strengths, and in the end, more precise information is decoded from the final updated latent representations.

In one important application case, for instance, according to an example embodiment of the present invention, the first measuring modality may include an acquisition of one or more optical image (s) of the scene using at least one camera, and the second measuring modality includes an acquisition of LIDAR data and/or radar data of the same scene. This is an especially advantageous configuration for monitoring the environment of a vehicle. Camera images are particularly useful for identifying classes of objects, but it is relatively difficult to determine the distance of an object from a camera image. Darkness or unfavorable weather conditions may also have an adverse effect on the quality of a camera image. LIDAR data and radar data directly supply the distance of an object, and radar measurements are also very robust with regard to unfavorable weather conditions. However, radar and LIDAR data show locations by which some interrogation radiation is reflected. It is more difficult to determine the class of an object from such reflexes than to determine the class of an object from an image of this object. Using the method described here, the two measuring modalities are able “to assist each other” and exchange information about features.

This may be especially helpful if one of the measuring modalities does not always function in the same way. For example, part of an image may only be of poorer quality because a direct ray of sunlight has driven part of the image sensor into saturation. The result is the occurrence of doubts or ambiguities in the detection of features from images. In such a situation, it is possible to use radar data, which are not affected by the ray of sunlight, in order to remove the doubt or the ambiguity. Conversely, if some radar reflexes are hidden because the radar radiation impinges upon an object made of a very soft material (such as a part made of foam material, or a fur coat of a pedestrian) , image information can be used to fill the gaps.

According to an example embodiment of the present invention, the first feature detector may encompass the convolutional section of a first neural network, which is designed as a classifier network. In the same way, the second feature detector may encompass a convolutional section of a second neural network, which is designed as a classifier network. The convolutional section includes at least one convolutional layer of the respective neural network, which is designed to process its input by a moving application of one or more filter cores. If a feature detector is organized in this manner, the first convolutional layer most likely identifies very primitive features, and each successively following convolutional layer is able to identify more complex features that are based on the previously detected features. If the neural network includes a plurality of convolutional layers that generate a latent representation in each case, the information flow between the first latent representation and the second latent representation may be applied to any desired combination of a convolutional layer of the first neural network and a convolutional layer of the second neural network. It is not even necessary for these layers to be situated at the same location in the respective neural networks. For instance, information may also flow between the last convolutional layer of the first neural network and the second-to-last layer of the second neural network.

The first decoder may include a classifier section and/or a regressor section of the first neural network. In the same way, the second decoder may include a classifier section and/or a regressor section of the second neural network. The classifier section and/or the regressor section include (s) at least one fully connected layer of the respective neural network. In this way, the improvements made to the respective latent representations are translated into an improved accuracy of the results that are output by the classifier section and/or the regressor section.

In one particularly advantageous embodiment of the present invention, after the decoding of updated information about features from the updated first and second representations, the present method branches back to a modification of features based on the new distances according to the positions that are included in the updated information. This means that the information exchange between features in the first latent representation and features in the second latent representation is able to be carried out multiple times in an iterative manner. This can be continued until a predetermined abort criterion such as a fixed number of iterations or a certain convergence of the modified latent representations is satisfied. If the abort criterion is satisfied, the then obtained decoded updated information about features from the respective updated latent representations is able to be used as the final detections that are derived from the measurement data of the respective measuring modality.

In a further, especially advantageous embodiment of the present invention, the features in the first latent representation and/or in the second latent representation may include information about a track or trajectory followed by a moving object. For instance, the features track segment (“tracklet”) can include information which indicates a segment of a track that a moving object is following. This leads to a certain degree of freedom with regard to the requirement that the first measurement data and the second measurement data be acquired simultaneously. Depending on the measurement structure, it may be difficult to obtain first measurement data and second measurement data that represent the scene at exactly the same time. A camera, for example, may perhaps require an exposure time that differs from the time required to emit a radar or LIDAR beam and to register the reflected beam. The signal processing paths leading from the respective raw data to the respective measurement data reaching the respective feature detector may also introduce different delays.

The predetermined update function depends on the specific application case and on the objective pursued by the fusion of the measurement data. More specifically, the application case and the objective may define the dependence of the update function on the distance between positions of features. This dependence is not restricted to a linear or continual dependence. For instance, this dependence may also be discontinuous insofar as the updating of a feature is a function of only a predefined number K of features in the respective other representation, the positions of which lie closest to the position of the feature to be updated. Also, before the “closest neighbors” are determined in this manner, subsets of the features may also be preselected in the latent representations. Only the features from these subsets may participate in the mutual updating of features. For instance, only features that are deemed “most promising” according to a metric defined in the context of each measuring modality may be included in the mutual updating of features. After the features have been preselected and/or connected to their closest neighbors, the effect of each feature on the updating of another feature may furthermore be a function of the specific value of the distance between the positions of the features. For example, it is possible to consider for the updating all K “closest neighbors” of a feature having the same weight.

According to an example embodiment of the present invention, the update function may be a parameterized function, for instance, and the parameters of this function can be optimized towards a certain objective. For example, the objective may include a maximization of a performance function by which the final decoded information about features is decoded. However, the update function may also be trained for any other suitable goal.

According to an example embodiment of the present invention, the first update function and the second update function may differ. For example, if the nature of the features that the first feature detector extracts from the first measurement data differs considerably from the nature of the features that the second feature detector extracts from the second measurement data, the update functions may include a type of translation between these types of features. But even if the nature of the features that are determined from the first and second measurement data is the same, a concept of directionality may be introduced in the updating process in that the first and the second update function are made to be different. A change in a feature by one unit in the first latent representation may cause a change in a connected feature by two units in the second latent representation, but a change in a feature by one unit in the second representation may cause only a change by one unit in a connected feature in the first latent representation.

If the first feature detector and the second feature detector extract approximately the same type of features from the respective measurement data, the first update function and the second update function can be merged to form a single update function. This means that the first feature detector and the second feature detectors are able to introduce an abstraction layer which reduces measurement data that were acquired using very different physical contrast mechanisms to a common denominator. For instance, images of a multitude of cameras mounted on a vehicle, radar data, LIDAR data, and possibly still further types of measurement data are able to be abstracted to features that indicate the presence and the characteristics of objects in the environment of the vehicle.

In one especially advantageous embodiment of the present invention, the first predefined update function and the second predefined update functions are realized in at least one common layer of a graphical neural network, GNN. Successive iterations are then able to be realized using further layers of this GNN. As a result, the entire process of fusing the measurement data is able to be implemented as a single GNN. This GNN differs from conventional GNNs at least in that an additional processing takes place between neighboring layers in order to decode updated positions of features from the updated features in the latent representations.

In a further, especially advantageous embodiment of the present invention, an actuation signal is generated based on the information about features that were decoded from the final obtained first latent representation and/or from the final obtained second latent representation. A vehicle and/or a quality assurance system and/or a monitoring system and/or a medical imaging system may then be actuated using this actuation signal. As discussed above, the fusion of the measurement data that were acquired using the first and second measuring modality leads to a refinement of the information that was decoded from the latent representations. This brings about a more accurate agreement between the actuation signal and the operating situation of the technical system to be actuated. The action which the technical system carries out in response to the actuation using this actuation signal is therefore more appropriate in such an operating situation.

The present invention also provides a method for training a trainable update function for use in the afore-described method. This training method is especially useful if the trainable update function is implemented in a neural network such as a graphical neural network, GNN. As a matter of principle, however, it can be applied to any type of update function whose behavior is marked by trainable parameters.

According to an example embodiment of the present invention, in the course of this method, first training patterns of measurement data of the first measuring modality are provided. A first portion of these first training examples is marked by information pertaining to features. At least a second portion of these first training patterns is preferably marked as negative examples that are free of the features to which the markings of the first portion of the first training patterns relate. For instance, the features may relate to objects, and the negative examples may be examples in which these objects are missing.

In the same way, second training patterns of measurement data of the second measuring modality are provided. At least a first portion of these second training patterns is marked by information pertaining to features. At least a second portion of the second training patterns is preferably marked as negative examples in which the features to which the markings of the first portion of the second training patterns relate are absent. For instance, the features may relate to objects, and the negative examples may be examples that do not include these objects.

First training patterns and second training patterns are fused with the aid of the above-described method. As discussed earlier, this leads to a final, updated second latent representation.

According to an example embodiment of the present invention, information about features that were decoded from the final updated first latent representation obtained from the first training patterns are compared to the markings allocated to these first training patterns. In other words, if a first training pattern is allocated to a certain marking, the information decoded from the final updated first latent representation agrees with this marking. If the first training example is a negative example lacking certain features, then the decoding from the final updated first latent representation should return zero information about these features. This means that the decoding should not return any information about features that are actually not present such as a type, dimensions or a velocity of an object that is not present.

In the same way, information about features that were decoded from the final updated second latent representation obtained from second training patterns, is compared to the features that are allocated to these second training patterns. In other words, if a second training pattern is allocated to a certain marking, then the information decoded from the final updated second latent representation should agree with this marking. If the second training example is a negative example without certain features, the decoding from the final updated first latent representation should return zero information about these features.

According to an example embodiment of the present invention, the results of these comparisons are evaluated with the aid of a predefined cost function. Parameters that characterize the behavior of the trainable update function are optimized based on the objective according to which the fusion of further first training patterns and second training patterns leads to a better evaluation by the cost function. This optimization may be continued until a predefined criterion has been satisfied, e.g., a maximum number of epochs in which all first and second training patterns have been cycled through once, a threshold value of the evaluation by the cost function, or a convergence of the training that manifests itself in a stagnation of the evaluation by the cost function.

After the update function has been trained in this way using training patterns offering a sufficient variability, it may be expected that it coordinates the mutual updating of features that are obtained from a large bandwidth of hidden first measurement data and second measurement data. Neural network such as graphical neural networks, GNN, for the implementation of the update function have an especially high ability of generalizing in this manner.

The present methods according to the present invention may be fully or partially computer-implemented. They may therefore be realized in a software that updates one or more computer (s) with the functionality of the method. As a consequence, the present invention also provides a computer program having machine-readable instructions that when executed on one or more computer (s), induce the one or the plurality of computer (s) to carry out one of the afore-described methods. The present invention also provides a non-volatile, machine-readable memory medium and/or a download product having the computer program. For example, a download program is a form of supplying the computer program which can be sold online for an immediate execution.

One or more computer (s) may also be provided with the computer program, the non-volatile, machine-readable memory medium, and/or the download product.

In the following text, further improvements of the present invention will be described in greater detail in combination with a description of preferred embodiments with the aid of figures.

### BRIEF DESCRIPTION OF THE DRAWINGS

FIG. 1 shows an exemplary embodiment of method 100 for fusing first measurement data 1 and second measurement data 2, according to the present invention.

FIG. 2 shows an illustration of the iterative development of latent representations 11, 12, according to an example embodiment of the present invention

FIG. 3 shows an exemplary embodiment of method 200 for training a trainable update function 1c, 2c, according to the present invention.

FIG. 4 shows an illustration of the training with positive and negative examples, according to an example embodiment of the present invention.

### DETAILED DESCRIPTION OF EXAMPLE EMBODIMENTS

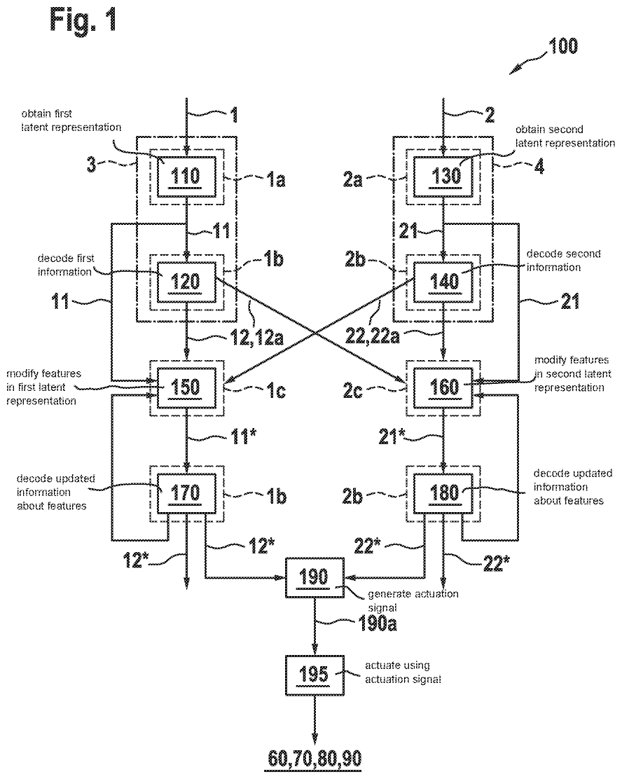

FIG. 1 is a schematic flow diagram of method 100 for fusing first measurement data 1 and second measurement data 2.

In step 110, a first latent representation 11 is obtained from first measurement data 1 with the aid of a first feature detector 1a. In step 120, first information 12 about features from first latent representation 11 is decoded with the aid of a first decoder 1b. First feature detector 1a and first decoder 1b, for example, may be taken from a first classifier network 3, which is conventionally used for classifying information 12 from first measurement data 1. As a minimum, information 12 includes positions 12a of features in space.

In the same way, a second latent representation 21 is obtained in step 130 from measurement data 2 with the aid of a second feature detector 2a. In step 140, second information 22 about features from second latent representation 21 is decoded with the aid of a second decoder 2b. Second feature detector 2a and second decoder 2b, for example, may be taken from a second classifier network 4, which is conventionally used for classifying information 22 from second measurement data 2.

In step 150, features in first latent representation 11 are modified based on features in second latent representation 21. This modification is controlled by a first predefined update function 1c. Whether first update function 1c modifies a feature in the first latent representation and, if so, to which extent, depends on a distance between position 12a of the feature decoded from first latent representation 11 and position 22a of the feature decoded from second latent representation 21. The result of the modification is an updated first latent representation 11*.

In the same way, features in second latent representation 21 are modified in step 160 based on features in first latent representation 11. This modification is controlled by a second predefined update function 2c. Whether second update function 2c modifies a feature in the second latent representation and, if so, to which extent, depends on a distance between position 22a of the feature decoded from second latent representation 21 and position 12a of the feature decoded from first latent representation 11. The result of the modification is an updated second latent representation 21*.

In step 170, updated information 12* about features from updated first latent representation 11* is decoded with the aid of first decoder 1b. In the same way, updated information 22* about features from updated second latent representation 21* is decoded in step 180 with the aid of second decoder 2b. Updated latent representations 11*, 12* may then be iteratively refined further according to steps 150 and 160 until a predefined abort criterion has been reached.

Based on updated information 12* and/or 22*, an actuation signal 190a is able to be generated in step 190. In step 195, a vehicle 60 and/or a quality assurance system 70 and/or a monitoring system 80 and/or a medical imaging system 90 is/are able to be actuated by this actuation signal.

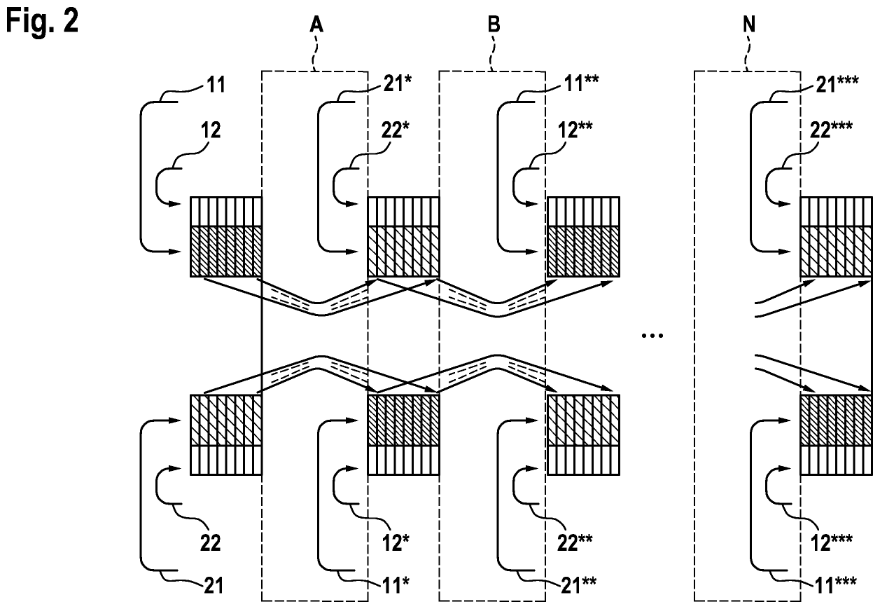

FIG. 2 illustrates the iterative updating of latent representations 11, 21 and decoded information 12, 22. In the example shown in FIG. 2, update functions 1c and 2c are realized by layers A, B, . . . , N of a graphical neural network, GNN.

During the processing in first layer A of the GNN, first latent representation 11 is used to update second latent representation 21 to a new second latent representation 21*, from which updated information 22* may be decoded. In the same way, second latent representation 21 is used to update first latent representation 11 to a new first latent representation 11*, from which updated information 12* is able to be decoded.

During the processing in second layer B of the GNN, updated second latent representation 22* is used to update updated first latent representation 12* to a further updated first latent representation 12**, from which further updated information 11** is able to be decoded. In the same way, updated first latent representation 11* is used to update updated second latent representation 21* to a further updated second latent representation 21**, from which further updated information 22** is able to be decoded.

This process is continued until the last layer N of the GNN is reached. Here, a final updated first latent representation 11*** is generated, from which the final information 12*** is able to be decoded. In the same way, a final updated second latent representation 21*** is generated, from which final information 22*** is able to be decoded.

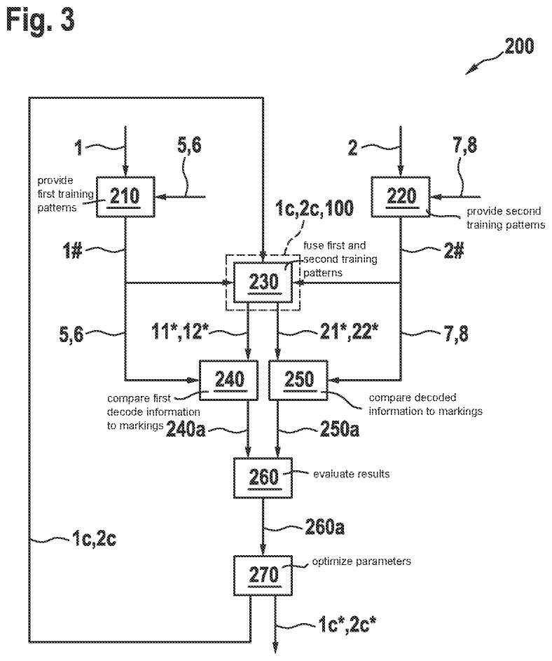

FIG. 3 shows a schematic flow diagram of an exemplary embodiment of method 200 for training a trainable update function 1c, 2c for use in the above-described method 100.

In step 210, first training patterns 1# of first measurement data 1 of the first measuring modality are provided. At least a first portion of these first training patterns 1# is marked with information 5 about features that should ideally be detected in these patterns 1#. Optionally, at least a second portion of first training patterns 1# has received a marking 6 as negative examples which are free of the features to which markings 5 relate.

In the same way, second training patterns 2# of second measurement data 2 of the second measuring modality are provided in step 220. At least a first portion of these second training patterns 2# is marked with information 7 about features that should ideally be detected in these examples 2#. Optionally, at least a second portion of second training patterns 2# has received a marking 8 as negative examples that are free of the features to which labels 7 relate.

In step 230, first training patterns 1# and second training patterns 2# which relate to the same situation (that is, relate to the same scene and the same time or are logically connected in a sequence of track pieces) are fused using method 100, as described above. This results in a final updated first latent representation 11*, from which information 12* is able to be decoded, and also a final updated second latent representation 21*, from which information 22* can be decoded.

In step 240, first decoded information 12*, which was ultimately derived for the first measuring modality, is compared to markings 5, 6 of first training patterns 1#, which provides a result 240a. In the same way, in step 250, decoded information 22*, which was ultimately derived for the second measuring modality, is compared to markings 7, 8 of second training patterns 2#, which provides a result 250a. Results 240a and 250a are evaluated in step 260 according to a predefined cost function. Based on evaluation 260a, parameters that characterize the behavior of trainable update function 1c, 2c are optimized in step 270. The goal of this optimization is that the fusing of further first training patterns 1# and second training patterns 2# leads to a better evaluation 260a by the cost function. The final trained state of the parameters of trainable update function 1c, 2c is marked by reference numeral 1c* and 2c*.

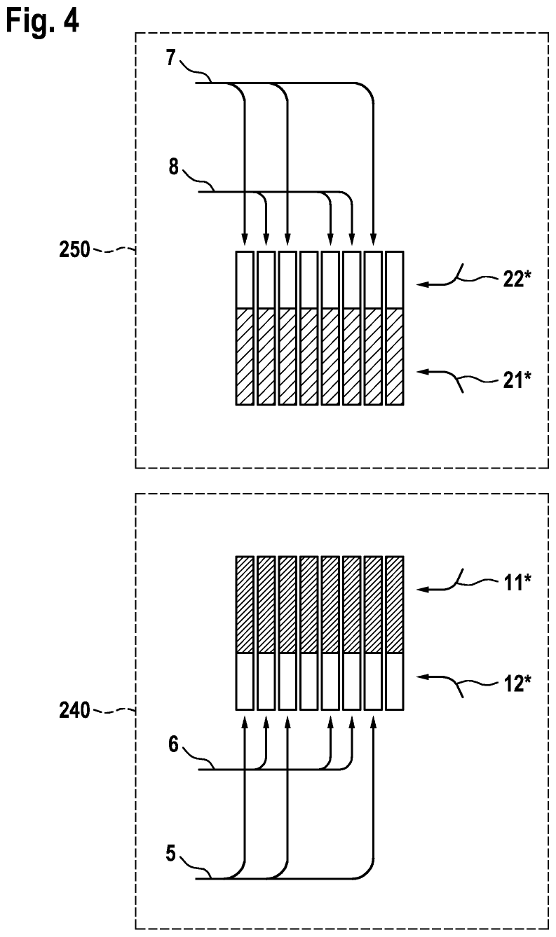

FIG. 4 illustrates the training with positive and negative examples. In step 240 of FIG. 3, information 12* that was decoded from modified first latent representation 11* is compared to markings that are allocated to the respective first training patterns 1#. A marking 5, which encodes the information that should ideally be decoded from this example 1#, is allocated to positive training patterns 1# that actually include features. A special marking 6, which encodes the absence of features, is allocated to negative training patterns 1# that are free of features. This means that either no information 12* should be decoded from a negative training pattern 1#, or this information 12* should explicitly indicate the absence of features.

The same applies to comparison 250 of information 22* which was decoded from modified second latent representation 21* with markings that are allocated to second training patterns 2#. A marking 7, which encodes the information that should ideally be decoded from this example 2#, is allocated to positive training patterns 2# which actually include features. A special marking 8 that encodes the absence of features is allocated to negative training patterns 2# that are free of features. This means that either no information 22* should be decoded from a negative training pattern 2#, or that this information 22* should explicitly indicate the absence of features.

1-14. (canceled)

15. A method for fusing first measurement data, which were acquired by monitoring a scene using a first measuring modality, with second measurement data, which were acquired by monitoring the same scene using a second measuring modality, the method comprising the following steps:
determining a first latent representation of features from the first measurement data using a first feature detector;
decoding first information about the features from the first latent representation using a first decoder, the first information including at least positions in space of the features from the first latent representation;
determining a second latent representation of features from the second measurement data using a second feature detector;
decoding second information about the features from the second latent representation using a second decoder, the second information including at least positions in space of the features from the second latent representation;
modifying the features in the first latent representation based on the features in the second latent representation according to a first predefined update function, whereby an updated first latent representation is generated, the first update function being a function of a distance between the position of a feature decoded from the first latent representation and the position of a feature decoded from the second latent representation;
modifying the features in the second latent representation based on the features in the first latent representation according to a second predefined update function, whereby an updated second latent representation is generated, the second update function being a function of a distance between a position of a feature decoded from the second latent representation and a position of a feature decoded from the first latent representation;
decoding updated information about the features from the updated first latent representation using the first decoder; and
decoding updated information about the features from the updated second latent representation using the second decoder.

16. The method as recited in claim 15, wherein:
the first feature detector includes a convolutional section of a first neural network, which is configured as a classifier network, and/or
the second feature detector includes a convolutional section of a second neural network, which is configured as a classifier network; and
wherein the convolutional section of the first neural network and/or the second neural network includes at least one convolutional layer of the first neural network and/or the second neural network, the at least one convolutional layer being configured to process its input by a moving application of one or more filter cores.

17. The method as recited in claim 16, wherein:
the first decoder includes a classifier section and/or a regressor section of the first neural network, and/or
the second decoder includes a classifier section and/or a regressor section of the second neural network; and
wherein the classifier section and/or the regressor section of the first decoder and/or second decoder includes at least one fully connected layer of the first neural network and/or the second neural network.

18. The method as recited in claim 15, wherein the first and/or second information about features that are decoded by the first decoder and/or by the second decoder, further include one or more of:
classifications,
a confidence of classifications,
dimensions, and orientations,
of objects that are represented by the features in the first and the second latent representation.

19. The method as recited in claim 15, further comprising: after the decoding of updated information about the features from the updated first latent representation and the features from the updated second latent representation, branching back to the modification of the features in the first latent representation based on new distances according to positions that are included in the updated information about the features from the updated first latent representation and the features from the updated second latent representation.

20. The method as recited in claim 15, wherein the features in the first latent representation and/or in the features in the second latent representation include information about a track or trajectory followed by a moving object.

21. The method as recited in claim 15, wherein the first measuring modality includes acquisition of one or more optical images of the scene using at least one camera, and the second measuring modality includes acquisition of LIDAR data and/or radar data of the same scene.

22. The method as recited in claim 15, wherein the first predefined update function and the second predefined update function are realized in at least one common layer of a graphical neural network (GNN).

23. The method as recited in claim 15, further comprising:
generating an actuation signal based on the information about features that were decoded from a final obtained first latent representation and/or from a final obtained second latent representation; and
actuating, using the actuation signal, a vehicle and/or a quality assurance system and/or a monitoring system and/or a medical imaging system.

24. A method for training a trainable update function, comprising the following steps:
providing first training patterns of measurement data of a first measuring modality in which at least a first portion of the first training patterns is marked with information about features;
providing second training patterns of measurement data of a second measuring modality in which at least a first portion of the second training patterns is marked with information about features;
fusing the first training patterns and the second training patterns by:
determining a first latent representation of features from the first training patterns using a first feature detector;
decoding first information about the features from the first latent representation using a first decoder, the first information including at least positions in space of the features from the first latent representation;
determining a second latent representation of features from the second training patterns using a second feature detector;
decoding second information about the features from the second latent representation using a second decoder, the second information including at least positions in space of the features from the second latent representation;
modifying the features in the first latent representation based on the features in the second latent representation according to a first predefined update function, whereby an updated first latent representation is generated, the first update function being a function of a distance between the position of a feature decoded from the first latent representation and the position of a feature decoded from the second latent representation;
modifying the features in the second latent representation based on the features in the first latent representation according to a second predefined update function, whereby an updated second latent representation is generated, the second update function being a function of a distance between a position of a feature decoded from the second latent representation and a position of a feature decoded from the first latent representation;
decoding updated information about the features from the updated first latent representation using the first decoder; and
decoding updated information about the features from the updated second latent representation using the second decoder;
first comparing information about features that were decoded from a final updated first latent representation obtained from the first training patterns, with the markings that are allocated to the first training patterns;
second comparing information about features that were decoded from a final obtained second latent representation obtained from the second training patterns, with the markings that are allocated to the second training patterns;
evaluating results of the first and second comparisons using a predefined cost function; and
optimizing parameters that characterize a behavior of the trainable update function with a goal that the fusing of further first training patterns and second training patterns leads to a better evaluation by the cost function.

25. The method as recited in claim 24, wherein:
at least a second portion of the first training patterns is marked as negative examples that are free of the features to which the markings of the first portion of the first training patterns relate, and/or
at least a second portion of the second training patterns is marked as negative examples that are free of the features to which the markings of the first portion of the second training patterns relate.

26. A non-transitory non-volatile machine-readable memory medium on which is stored a computer program for fusing first measurement data, which were acquired by monitoring a scene using a first measuring modality, with second measurement data, which were acquired by monitoring the same scene using a second measuring modality, the computer program, when executed by one or more computers, causing the one or more computers to perform the following steps:
determining a first latent representation of features from the first measurement data using a first feature detector;
decoding first information about the features from the first latent representation using a first decoder, the first information including at least positions in space of the features from the first latent representation;
determining a second latent representation of features from the second measurement data using a second feature detector;
decoding second information about the features from the second latent representation using a second decoder, the second information including at least positions in space of the features from the second latent representation;
modifying the features in the first latent representation based on the features in the second latent representation according to a first predefined update function, whereby an updated first latent representation is generated, the first update function being a function of a distance between the position of a feature decoded from the first latent representation and the position of a feature decoded from the second latent representation;
modifying the features in the second latent representation based on the features in the first latent representation according to a second predefined update function, whereby an updated second latent representation is generated, the second update function being a function of a distance between a position of a feature decoded from the second latent representation and a position of a feature decoded from the first latent representation;
decoding updated information about the features from the updated first latent representation using the first decoder; and
decoding updated information about the features from the updated second latent representation using the second decoder.

27. One or more computers configured to fuse first measurement data, which were acquired by monitoring a scene using a first measuring modality, with second measurement data, which were acquired by monitoring the same scene using a second measuring modality, the one or more computers configured to:
determine a first latent representation of features from the first measurement data using a first feature detector;
decode first information about the features from the first latent representation using a first decoder, the first information including at least positions in space of the features from the first latent representation;
determine a second latent representation of features from the second measurement data using a second feature detector;
decode second information about the features from the second latent representation using a second decoder, the second information including at least positions in space of the features from the second latent representation;
modify the features in the first latent representation based on the features in the second latent representation according to a first predefined update function, whereby an updated first latent representation is generated, the first update function being a function of a distance between the position of a feature decoded from the first latent representation and the position of a feature decoded from the second latent representation;
modify the features in the second latent representation based on the features in the first latent representation according to a second predefined update function, whereby an updated second latent representation is generated, the second update function being a function of a distance between a position of a feature decoded from the second latent representation and a position of a feature decoded from the first latent representation;
decode updated information about the features from the updated first latent representation using the first decoder; and
decode updated information about the features from the updated second latent representation using the second decoder.
